(19) United States
(12) Patent Application Publication
(10) Pub. No.: US 2007/0031137 A1
(43) Pub. Date: Feb. 8, 2007

(54) Optical module comprising a spacer element between the housing of a semiconductor element and a lens unit

(75) Inventors: Danut Bogdan, Timisoara (RO); Jozef Dimeyer, Bodenwohr (DE); Henryk Frenzel, Regensburg (DE); Harald Schmidt, Regensburg (DE)

Correspondence Address: LERNER GREENBERG STEMER LLP, P O BOX 2480, HOLLYWOOD, FL, 33022-2480, US

(73) Assignee: Siemens AG, München (DE)

(21) Appl. No.: 10/573,538

(22) PCT Filed: Sep. 15, 2004
(86) PCT No.: PCT/EP04/52187

§ 371 Date: Apr. 26, 2006

(30) Foreign Application Priority Data
Sep. 26, 2003 (DE) 103 44 770.9

(51) Int. Cl. G02B 7/28

(52) U.S. Cl. 396/114

(57) ABSTRACT

An optical module has a circuit carrier, a housed semiconductor element disposed on the circuit carrier, and a lens unit for projecting electromagnetic radiation along an optical axis towards the semiconductor element. The housed semiconductor element and the lens unit are embodied as two components. At least one spacer element is disposed outside the optical axis, between the housing of the semiconductor element and the lens unit. Due to the addition of a low-cost spacer element, the invention enables the simple compensation of possible remaining work tolerances, for example between client-specific semiconductor housings and lens units selected from lines of products of different production quality. While tolerance-exceeding lines of products have not had any use until now as rejects, reliable camera modules can advantageously be assembled using a compensation element according to the invention, and in principle, any mechanical adjustment of the focal point can also be dispensed with. Such camera modules can be suitable utilized inside a motor vehicle or outside of the same.

The invention relates to an optical module with a circuit carrier, a housed semiconductor element arranged on the circuit carrier and a lens unit for projecting electromagnetic radiation along an optical axis onto the semiconductor element, with the housed semiconductor element and the lens being embodied as two components.

The invention further relates to an optical system with an optical module embodied in this way.

Generic optical modules and systems are used especially in automotive technology.

In such cases operation can be with electromagnetic radiation from different frequency ranges, in which case cumulatively to the visible light, with which applications in the exterior area of a motor vehicle typically operate, such as LDW (Lane Departure Warning), BSD (Blind Spot Detection), or (Rear View Cameras), the infrared light which is invisible to the human eye is preferred for applications in the interior of the motor vehicle such as OOP (Out of Position Detection) or for additional outside illumination of a night vision system.

High demands are imposed on applications in the interior and exterior area of a vehicle as a result of external influences such as temperature, moisture, contamination and vibration. The typical lifetime for systems in the motor vehicle is around 10 to 15 years, with only extremely low failure rates being tolerated, so that the components of an optical system of the type mentioned at the start may only exhibit very slow ageing.

Since in many cases the space for installing optical modules or optical systems is very restricted, additional difficulties arise in implementing the optical systems. It is thus extremely difficult using conventional means to construct a hermetically sealed reliable unit consisting of a camera chip (currently CCD or CMOS sensors) and optics.

To achieve sufficiently sharp focus for a camera system, consisting of an image sensor (currently CCD or CMOS) and a lens system, the sensor and optics components must be matched geometrically very precisely to one another. The tolerance range for the distance from camera chip to optics in the z-axis usually lies within the range of a few hundredths of a millimeter, in order to achieve an optimally sharp image for a specific depth of field. This is a particularly a problem for so-called fixed-focus systems, since this tolerance which is small in any event may be exceeded during manufacturing. An additional consequence of an offset of camera chip to optics in the x- or y-axis is also that under some circumstances the optical system “squints”, i.e. the image is truncated on one edge (horizontal or vertical), since the offset means that pixels are no longer present here and would have to be provided as a precaution.

A further problem is presented by “tilt”, i.e. a misalignment of the camera chip around the x- or y-axis, resulting in the image exhibiting an out-of-focus gradient in the horizontal or vertical direction. In addition a “rotation” can also be produced, i.e. a rotation around the z-axis of camera chip to optics.

Almost all camera systems currently on the market which are supplied with a fixed focus setting need an additional compensation step during manufacturing, in which the distance from camera chip to optics along the z-axis is set and is fixed at this value. This is done for example using a thread and a corresponding adjustment screw or a glue connection. A compensation step can also be necessary for the x-y offset or, if this is not done, a correspondingly larger sensor can be provided which provides more pixels to allow for the tolerances. Software which processes or calibrates out the rotation is also known. Since otherwise sharp image information is present, the pixels only need to be reassigned in a type of “calibration” process. However there can no longer be any information at the edges or corners since these are truncated. Finally, a purely mechanical reduction of “tilt” and “rotation” between chip and optics can as a rule only be achieved with usual systems by high-precision manufacturing and assembly or by calibrating the components.

However cameras for specific low-cost applications such as automotive, industry, digital camera, mobiles, toys etc. should be manufactured from the standpoint of cost and of quality assurance aspects where possible without adjustment procedures between optics and camera chip, that is without making adjustments to the focus on the optical surface of the CMOS or CCD sensor. This basically conflicts with the stated requirements.

One possibility for developing a focus-free system is to reduce the sums of the possible tolerances and elements, so that the module or system functions as a result of the design without adjustment in at least one specific distance and temperature range. Where the invention is used for example within the framework of an occupant protection system of a motor vehicle, to which the present invention is however not restricted, sharper images at distances of for example 15 cm to 130 cm as well as at temperatures of for example −40° C. to +105° C. should be able to be guaranteed. The fewer elements are included in the tolerance chain, the easier this is to implement. A large element in the tolerance chain is taken up by the circuit carrier for the camera chip (currently CCD or CMOS for example). With housed semiconductor elements the soldered or glued connections or such like necessary between the chip and the circuit carrier in particular constitute a large element in the tolerance chain.

Using only one lens avoids additional optical tolerances being caused by a complicated lens construction. The lens holder, which is preferably made of plastic, can itself be connected to the lens arrangement in different ways so that an exact optical alignment of the lens arrangement and of the semiconductor element in relation to the lens holder or the lens arrangement respectively can always be ensured

However with systems which largely feature a classical layout consisting of lens and camera chip, with the camera chip or the semiconductor element being accommodated in a housing on a suitable circuit carrier, it is difficult to get around the given overall problems and simultaneously meet the given quality requirements. With housed semiconductor chips it is true to say that only particular measures need be taken to protect the front of the package from outside light radiation or other environmental influences, since the chip package offers sufficient protection from behind, e.g. for the Silicon which lets through IR radiation. The lens itself must however be adjusted to the camera chip and feature a defined focusing. This is done at present using tolerance-prone adjustment options through screwing, gluing or such like, by means of which the lens is fixed relative to the camera chip on the circuit carrier.

The object of the invention is to make available an optical module and an optical system with a housed semiconductor element arranged on a circuit carrier in which any possible tolerances which may remain can be compensated for, so that with a simple and cost-effective assembly a reliable optical quality without adjustment and especially focusing effort can be provided and can be maintained over the lifetime of the module or system.

This object is achieved with the features of the independent claims. Advantageous embodiments of the invention, which can be used individually or in combination with each other, are specified in the dependent claims.

The invention builds on the generic optical module by providing, outside the optical axis between the housing of the semiconductor element and the lens unit at least one spacer element, which is also referred to as a spacer. In this way any remaining manufacturing tolerances between semiconductor package and lens unit, as a result of wear to tools for example or other differences within one or between different manufacturing lots or producer-specific versions or such like can be advantageously compensated for.

Preferably the spacer element is embodied as a foil or washer, for example like a shim in the form of a circular washer. Circular washers generally allow defined, e.g. planar surfaces to be embodied, whereby an even support can be implemented which advantageously largely eliminates the components tilting in relation to one another.

To implement a simple production process the spacer element is preferably a punched part. With spacer elements with a very small thickness of a few tenths or hundredths of millimeters especially, these parts can be advantageously punched from a foil.

To make it easier to fix the spacer elements to the adjacent components and/or to each other, the spacer element is embodied with at least one adhesive side, preferably two. These types of spacer elements can for example be manufactured simply from a single-sided or double-sided adhesive tape or an adhesive foil, preferably punched out.

In accordance with the invention the spacer element is preferably part of a set of elements, preferably comprising two or more spacer elements of different predefined thicknesses or with one uniform basic thickness and increased or reduced nominal dimensions in relation to this. A typical set of elements would for example be spacer elements with nominal differences in dimension from +/−0.005 mm or +/−0.01 mm to +/−0.03 mm or such like. In this way any remaining tolerance differences between semiconductor housing and lens unit can basically be compensated for without any great adjustment effort.

To improve the optical characteristics of a module at least one spacer is embodied in accordance with the invention preferably simultaneously as a diaphragm, lens hood or such like and can thus reduce the need for special hoods.

The spacer element is made in an appropriate manner from a plastic, for example of thermoplastic.

The invention further comprises an optical system with an optical module of the type stated above. In this way the advantages of the optical module can also be brought to bear within the framework of an overall system.

The invention is based on the knowledge that any remaining manufacturing tolerances, especially between housed semiconductor chips and lens units of different lines of products, can be compensated for simply and at low cost by means of at least one specially embodied spacer element. The optical module can thus be developed without moving parts such as threads or fixing screws, which leads to greater reliability. The smaller tolerances of the design, including in the x- and y-axis, mean that the chip surface do not have to be unnecessarily large, which makes the camera chip cheaper. Such a module can be a very compact design which has the advantage of allowing the camera module to also be used in applications where space is restricted.

The invention can be employed especially usefully in the implementation of video systems, if necessary in combination with radar systems, ultrasound systems or such like in the automotive area.

The invention is now explained with reference to the accompanying drawings with reference to preferred embodiments.

The figures show schematic diagrams of:

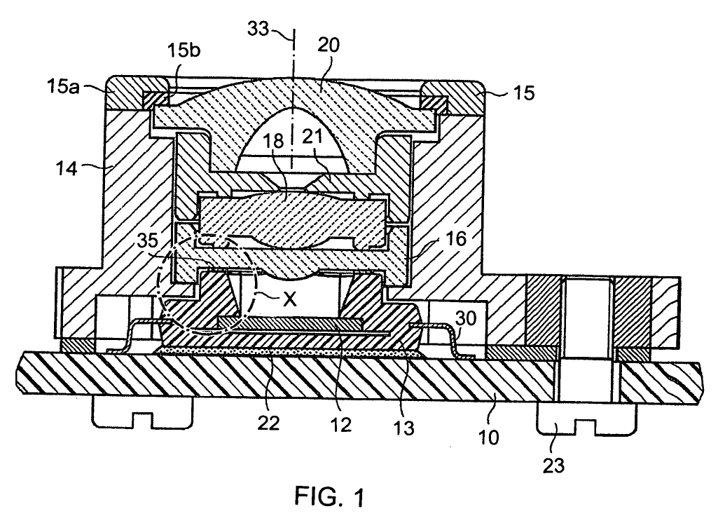

FIG. 1 the arrangement of an inventive spacer element, shown in a cross-sectional view of an inventive optical module with a client-specific semiconductor element housing.

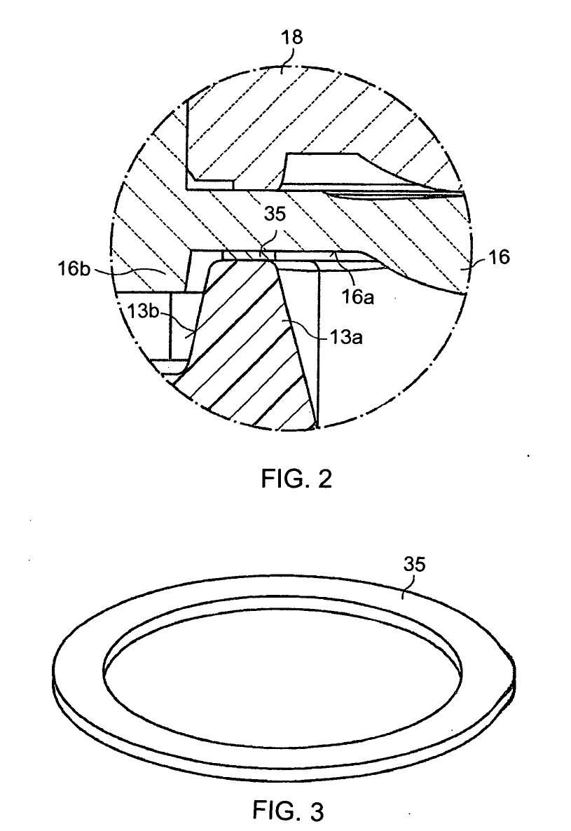

FIG. 2 an enlarged section X of the module in accordance with FIG. 1;

FIG. 3 a spacer element used in accordance with the invention, shown on its own; and

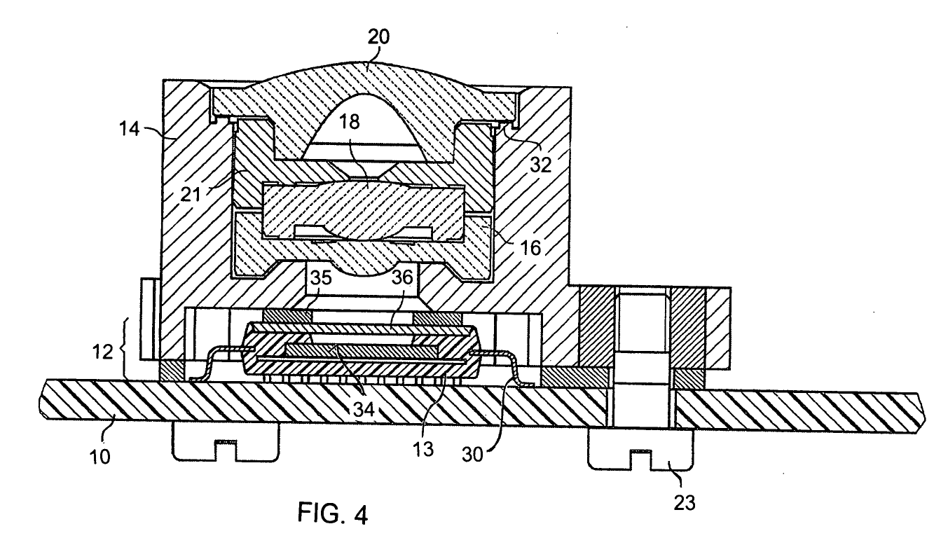

FIG. 4 the arrangement of an inventive spacer element in a cross-sectional view of an inventive optical module with a client-specific semiconductor element housing.

In the description of the preferred embodiment of the present invention below the same reference symbols refer to the same or comparable components.

FIGS. 1 to 5 show, in different cross-sections and views, the arrangement of an inventive spacer element 35 in an optical module with a circuit carrier 10; A housed semiconductor element 12 and a lens unit 14; 16, 18, 20; 21 for projecting electromagnetic radiation along an optical axis 33 onto the semiconductor element 12 arranged on the circuit carrier 10. The lens unit 14; 16, 18, 20; 21 embodied separately from the housed semiconductor element 12 comprises a lens holder 14 and a lens arrangement 16, 18, 20; 21 with at least one lens 20 and if necessary one diaphragm 21.

The semiconductor element 12 can be arranged in a standard housing (cf. FIG. 4 below) or in a client-specific SMD housing (cf. FIG. 1 and 2).

The exemplary embodiment depicted in FIG. 1 is based on a client-specific SMD housing 13. A support 13a is for example embodied on at least sections of this housing 13, on which the lens unit 14;16, 18, 20; 21 is supported. The lens unit 14; 16, 18, 20; 21 is supported either via the lens 16, which is preferably embodied as a type of support lens 16, or via the lens holder 14 (not shown). Support lens 16 or lens holder in this connection feature at least one flat section 16a embodied at least in sections to correspond to support 13a, which for example is embodied flat and rests on the support 13a embodied on the package 13 of the semiconductor element 12. In addition, at least in some sections, the lens 16 or the lens holder features a skirt 16b, which is essentially embodied to correspond to a support surface 13b embodied on the support 13a. The support 13a is thus preferably embodied in the form of a ring skirt 13a. The support surface 13b of the ring skirt 13a is embodied, preferably conically, viewed in the direction of the optical axis 33 of the module, so that not only for automated production a type of self-centering of adjacent components forward from the lens 16 and support 13a is advantageously made possible more easily.

Preferably a lens arrangement 14; 16, 18, 20; 21 with a number of lenses 16, 18, 20 and if necessary at least one diaphragm 21 is provided in the form of a package. The optical quality can be improved by a lens with a number of lenses, which is also possible within the framework of the present invention, especially since it is possible to work with fine tolerances here. In this context it is also especially advantageous for the lenses 16, 18, 20 and where necessary the diaphragm 21 to be in direct contact with each other. In practice this excludes fluctuations of the lens arrangement 16, 18, 20; 21 in the z-direction, meaning in the direction in which the lenses follow each other. The tolerances not only depend on the lens arrangement 16, 18, 20; 21 itself. Likewise it is especially useful for the relative positions of the lenses to each other to be determined by the geometry of the lenses 16, 18, 20 and if necessary diaphragms 21. The arrangement of the lenses can also be determined in the x-y direction by the lenses themselves, by the contact surfaces of the lenses or diaphragms being designed accordingly.

The lenses 16, 18, 20 or diaphragms 21 supported in the lens holder 14 are preferably also formed so that they assume a defined position within the lens holder 14 in relation to each other. Furthermore at least one of the lenses 20 is designed, so that it operates in conjunction with the lens holder 14 and thus also assumes a defined position in relation to the semiconductor element 12. In this manner all lenses 16, 18, 20 are adjusted in relation to the semiconductor element 12.

This adjustment will also not be compromised by the lens holder 14 being connected for example via a screw connection 23 to the circuit carrier 10. The housed semiconductor element 12 is arranged on the circuit carrier 10 via lead frames 30 for example. In addition a glued connection 22 or other known connection techniques can be provided.

It is especially useful for precisely one of the lenses or diaphragms to be in direct contact with the lens holder (not shown). Since the lenses define their positions relative to one another, it is sufficient to fix precisely one lens or diaphragm to the lens holder. In this way the overall lens arrangement is aligned in relation to the semiconductor element, which in the final analysis allows the advantageous optical quality to be ensured. In this context it is especially advantageous for the precisely one lens to be connected in a waterproof and dustproof manner to the lens holder. Advantageously the frontmost lens will be selected for this purpose as the lens to form the seal with the lens holder. This can be done in the following way for example; by the precisely one lens being connected to the lens holder by ultrasound, laser welding and/or gluing, if necessary alternatively or cumulatively using screws and /or mastic.

There can also be provision for the lens arrangement to be a snap-in fit in the area holding the lens by using retaining means 32 (cf. FIG. 4). Exact positioning can also be ensured in this way. Furthermore it should be stressed that this provides an easier facility for separating the lenses from the other components, especially the expensive semiconductor element. The sealing effect is especially provided in an advantageous manner in conjunction with a snap-on the assembly by the lenses featuring a hard and a soft component, with the soft component being arranged around the circumference of the lens to make the seal (not shown). The soft component also supports the general requirement for not introducing any strains into the lenses 16, 18, 20; 21 during snap-on assembly; Strains would always have a negative effect on the optical characteristics.

Preferably in the exemplary embodiment in accordance with FIG. 1 the lens arrangement 16, 18, 20; 21 is retained via a retaining element 15 (molded ring) in the lens holder 14. The retaining element 15 preferably features one hard 15a and, at least in sections, one permanently flexible component 15b. A permanently flexible component 15b preferably embodied to run around the circumference can especially also be used at the same time to seal the lens arrangement 16, 18, 20; 21 against moisture and dirt—as well as its own compensation function for any mechanical and/or thermally produced strains-which occur. The permanently flexible component 15b is preferably embodied on the circumference on which the lens 20 rests. In the area of the harder component 15a the retaining element 15 is arranged on the area 14 retaining the lens, for example ultrasound or laser welded, glued, riveted, molded or connected by means of another method which is easy to automate. Screw and snap-on connections are also conceivable. Preferably the hard component 15a of the retaining ring 15 contains a thermoplastic material. Accordingly a permanently flexible component 15b has proven itself which preferably contains thermoplastic elastomers (TPE) or Silicon or such like. For the purposes of providing a uniform and easy-to-handle component 15 both the permanently flexible component 15b is molded onto the hard component 15a for example in accordance with a two-component injection method or vice-versa.

It can further be especially advantageous for undesired optical effects, especially as a result of light entering from the side, to be prevented by darkening and/or applying a matt surface or by using total reflection (not shown). This involves examples of suitable measures.

Finally provision is usefully made for the module to be able to be connected via a flat cable or especially when a flexible printed circuit board is used as the circuit carrier, by means of this to a rigid circuit board (the latter are all also known as rigid-flex systems) especially (for example by means of hot bar soldering) As regards angle and position etc. this is an especially flexible solution for connecting the circuit carrier 10 or the module to a controller or a circuit board (not shown).

For the purposes of compensating for any manufacturing tolerances of the semiconductor chip 12 and/or the lens unit 14;16, 18, 20; 21, in accordance with the invention, at least one spacer element, which does not adversely affect the entry of the main beam 33 and is also referred to as a spacer, is arranged outside the optical axis 33 between the housing 13 of the semiconductor element 12 and the lens unit 14;16, 18, 20; 21. In the exemplary embodiment in accordance with FIG. 1 or 2, that is a client-specific housed semiconductor element 12, the spacer element lies between support 13a and the lens 16 or the lens holder 14.

FIG. 3 shows an inventive spacer element on its own; For example the spacer element 35 is punched out of a foil. Also conceivable are spacer elements 35 embodied in the form of rings for example in the shape of a circular washer. In any event self-adhesive spacers 35 have proven themselves in a manufacturing and assembly. Preferably in accordance with the invention the spacer element 35 is part of a set of elements a, b, c, with at least two or more spacer elements 35a, 35b, 35c of uniform predefined basic thickness and of different nominal dimensions increasing or reducing these elements in each case. For example the set of elements a, b, c, can comprise distance elements 35 with nominal dimension changes from +/−0.005 mm or +/−0.01 mm to +/−0.03 mm or such like. In an advantageous development of the optical characteristics of the module the distance element 35 can preferably be embodied as a diaphragm, a lens hood or such like, which, depending on application design, advantageously allows a reduction in its parts.

FIG. 4 shows the arrangement of an inventive spacer element 35 in a cross-sectional view of an inventive optical module with a standard housed semiconductor element 12. In this case the spacer 35 element rests against a transparent glass cover 36 which protects the sensitive surface 34 of the semiconductor chip 12 in particular against dust etc. With standard chips without covers (not shown) the spacer element 35 can obviously also be arranged directly on the chip housing 13.

With the present invention any manufacturing tolerances, e.g. of the supports 13a of a client-specific chip housing 13 or valuable lens units 14; 16, 18, 20; 21 or such like can advantageously be adapted by easy-to-handle spacer elements 35, which are preferably available in the form of a set of elements a, b, c, . . . for typical thicknesses for lines of products of different manufacturing quality. Whereas previously lines of products which did not comply with tolerances were scrapped and could not be put to any use, with the inventive use proposed at least one spacer element 35 advantageously allows the construction of reliable camera modules in which basically any mechanical focus setting can still be dispensed with. In particular the optical module can be assembled without any moving parts such as threads or fixing screws. The otherwise small tolerances of the layout, including in the x- and y-axis, mean that the chip surface 34 does not have to be unnecessarily large, which makes the camera chip smaller. The layout of such a module can be a comparatively compact design which has the advantage that the camera module can also be used in applications where space is restricted. Furthermore the layout described offers the opportunity of designing a hermetically sealed module which is protected against environmental influences such as moisture or dust.

The features of the invention disclosed in this description, in the drawings and in the claims can be of importance both individually and in any combination for implementing the invention. They are especially suitable for applications in the interior and/or exterior area of a motor vehicle.

1-10. (canceled)

11. An optical module, comprising:
a circuit carrier;
a semiconductor element contained in a housing disposed on said circuit carrier; and
a lens unit configured for projecting electromagnetic radiation along an optical axis onto said semiconductor element;
said housing with said semiconductor element and said lens unit, respectively, forming two components;
a spacer element disposed outside the optical axis between said housing of said semiconductor element and said lens unit.

12. The optical module according to claim 11, wherein said spacer element is a foil or a washer.

13. The optical module according to claim 11, wherein said spacer element is a circular washer.

14. The optical module according to claim 11, wherein said spacer element is a punched part.

15. The optical module according to claim 11, wherein said spacer element has adhesive properties on at least one side thereof.

16. The optical module according to claim 11, wherein said spacer element is adhesive on both sides thereof.

17. The optical module according to claim 11, wherein said spacer element forms a part of a set of elements.

18. The optical module according to claim 17, wherein said set of elements comprises two or more spacer elements with a uniform basic thickness and mutually different nominal thicknesses.

19. The optical module according to claim 18, wherein said nominal thicknesses of said two or more spacer elements sequentially increase or reduce said uniform basic thickness.

20. The optical module according to claim 18, wherein said spacer elements are formed with nominal dimension changes from +/−0.005 mm.

21. The optical module according to claim 18, wherein said spacer elements are formed with nominal dimension changes from +/−0.01 mm to +/−0.03 mm.

22. The optical module according to claim 11, wherein said at least one spacer element is simultaneously formed as a diaphragm or a lens hood.

23. The optical module according to claim 11, wherein said spacer element is made from a plastic.

24. The optical module according to claim 11, wherein said spacer element is made from a thermoplastic material.

25. An optical system, comprising an optical module in accordance with claim 11.
